(19) United States
(12) Patent Application Publication
(10) Pub. No.: US 2007/0209582 A1
(43) Pub. Date: Sep. 13, 2007

(54) Coating apparatus

(76) Inventors: Narimichi Takei, Shinjuku-ku (JP); Kazuomi Unosawa, Shinjuku-ku (JP); Kuniaki Yamanaka, Shinjuku-ku (JP); Shigemi Isobe, Shinjuku-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/708,319

(22) Filed: Feb. 21, 2007

(30) Foreign Application Priority Data
Mar. 10, 2006 (JP) 2006-66558

(51) Int. Cl. B05C 5/00

(52) U.S. Cl. 118/300

(57) ABSTRACT

A rotating drum 3 has ventilation sections 6 that can ventilate the inside of the drum and the outside of the drum in the coating processing. To the ventilation sections 6, a panel unit 41 having arranged therein plural hollow pipes 42 through which cold water passes is attached. The hollow pipes 42 are fixed to a base plate 44 in parallel with each other, and a gap “G” is provided between the adjacent pipes. The base plate 44 is provided with a communication hole 45, and the hollow pipes 42 are so arranged as to face the communication hole 45. To both ends of the hollow pipes 42, charge/discharge collecting pipes 46a and 46b are fixed. In the coating processing, cold water is arbitrarily supplied to the hollow pipes 42 through the charge/discharge collecting pipe 46a to cool the drum 3 so as to bring about the temperature difference between the inside of the drum and processing objects, which can prevent coating base materials from adhering to the inside of the drum.

### BACKGROUND OF THE INVENTION

1. Field of the Invention

The present invention relates to a coating apparatus using a rotating container in the form of a drum, and more particularly, to a ventilation-type pan coating apparatus that is employed in the coating processing for tablets, foods, etc.

2. Related Art Statement

Conventionally, as a production device for medical products, foods, etc., there is known a coating apparatus using a rotating drum. For example, in Jpn. Pat. Appln. Laid-Open Publication No. 6-63376, there is disclosed a device provided with a rotating drum of polygonal configuration in cross-section (octagon, in this case) called “coating pan”. FIG. 13 shows a view to explain the configuration of such a conventional coating apparatus 100. As shown in FIG. 13, a rotating drum 101 rotates with the horizontal axis line “O” being the rotation center. In the drum 101, a spray unit 102 is arranged. Powder and particle thrown into the drum 101 is rolled as the drum 101 rotates. To the surface of the powder and particle, coating liquid is sprayed from the spray unit 102. In the coating processing, to or from the drum 101, hot air or cold air is arbitrarily charged or discharged from a charging duct 103 or to a discharging duct 104 so as to form and dry coating layers.

In the coating processing, hot air or cold air is arbitrarily charged to processing objects from the duct 103. On a main trunk section 105 of the drum 101, there is formed a ventilation section 106 being a porous plate. Air that passes through a processing object layer flows into the duct 104 from the ventilation section 106. That is, air charged to the inside of the drum 101 from the duct 103 firstly passes through the processing object layer. Then, the air is discharged to the duct 104 arranged at the outer circumference of the drum 101 through the ventilation section 106. In this way, in the coating apparatus 100, dry air charged and discharged from and to the ducts 103, 104 makes coating base materials dry and get hard on the processing object surface, forming a coating layer.

However, in the coating apparatus 100, since dry air passing through the processing object layer is discharged through the ventilation section 106, the temperature of the drum 101 rises (or falls) in the coating processing, and the temperature of the ventilation section 106 becomes substantially equal to that of the processing objects. Accordingly, there is undesirably raised a fear that coating base materials are solidified to adhere to the inside of the drum 101. For example, in case of the glycocalyx coating processing, the drum 101 is heated by dry air, and base materials of glycocalyx liquid (saccharose) are easily solidified to adhere to the inside of the drum 101, especially to the ventilation section 106. Furthermore, in case of the chocolate coating processing, when cold air is charged from the duct 103, similarly, since the temperature of the ventilation section 106 becomes substantially equal to that of the processing objects, chocolate is easily solidified to adhere to the inside of the drum 101.

When such solidified materials adhere to the inside of the drum in the coating processing, there may be raised a case in which the solidified materials are peeled off and adhere to products, which leads to the cause of defective products having a spot or a protrusion. Accordingly, in the actual coating processing, when the amount of materials adhering to the inside of the drum becomes large, the rotating drum is suspended and the adhering materials are discharged to the outside of the drum. That is, in employing the conventional device, so as to prevent producing defective products, it is necessary to arbitrarily clean up the inside of the rotating drum in the coating processing. As a result, there are raised problems that the production efficiency is lowered and the process time period becomes long, and in cleaning the drum, a time period required for the cleaning becomes long since the amount of the adhering materials is large.

### SUMMARY OF THE INVENTION

Accordingly, the present invention has an object to prevent coating base materials from adhering to the inside of a rotating drum. By realizing the object, it becomes possible to prevent producing defective products due to the peeling off of adhering materials. Furthermore, the cleaning process for removing adhering materials can be cut out, leading to the improvement of the production efficiency.

According to the present invention there is provided a coating apparatus, including: a hollow processing container which is rotatably arranged with its rotation axis being the center; and a ventilation section which is arranged in the processing container, and can ventilate the inside of the processing container and the outside of the processing container in the coating processing; wherein the ventilation section has a temperature adjustment unit which is provided with a temperature-adjusting section through which temperature-adjusting medium passes, and a communicating section which makes the inside of the processing container communicate with the outside of the processing container.

According to the present invention, in the ventilation section arranged in the processing container of the coating apparatus, there is arranged the temperature adjustment unit which is provided with the temperature-adjusting section through which temperature-adjusting medium passes, and the communicating section which makes the inside of the processing container communicate with the outside of the processing container, and in the coating processing, the temperature adjustment unit adjusts the temperature of the processing container, especially the ventilation section, while carrying out ventilation. Accordingly, in the coating processing, the temperature of the processing container is arbitrarily adjusted, and the temperature difference is brought about between the inside of the processing container and processing objects, which can prevent coating base materials from adhering to the inside of the processing container, especially the ventilation section.

In the coating apparatus, in the temperature-adjusting section, there may be arranged hollow temperature-adjusting tubes through which the temperature-adjusting medium passes. Furthermore, the temperature-adjusting tubes may be prepared by a plural number, and a gap may be provided between the adjacent temperature-adjusting tubes so as to form the communicating section. Moreover, the temperature-adjusting tubes may be so arranged as to be parallel with each other. Additionally, the temperature adjustment unit may have a base plate in the form of a flat plate which is provided with at the center thereof a communication hole, and the temperature-adjusting tubes may be fixed to the base plate and may be so arranged as to face the communication hole. Furthermore, the temperature adjustment unit may further have temperature-adjusting medium charge/discharge collecting members which are arranged on at least any one of both sides of the temperature-adjusting tubes, and are connected to the ends of the respective temperature-adjusting tubes and communicate with the respective temperature-adjusting tubes.

In the coating apparatus according to the present invention, the temperature adjustment unit may have a temperature-adjusting section being a hollow box-shaped member through which the temperature-adjusting medium passes, and a communicating section being hollow pipes which are arranged in the box-shaped member and open into the front-back both sides of the box-shaped member.

Furthermore, in the coating apparatus according to the present invention, the temperature adjustment unit may have a base plate in the form of a flat plate which is provided with a plurality of ventilation holes, and the temperature-adjusting tube may be fixed to the base plate. In this case, the temperature-adjusting tube may be arranged at part of the base plate where the ventilation holes are not provided.

Moreover, in the coating apparatus according to the present invention, the temperature adjustment unit may have temperature-adjusting medium charge/discharge collecting members which are arranged on both sides of the temperature-adjusting tubes, and are connected to the ends of the respective temperature-adjusting tubes and communicate with the respective temperature-adjusting tubes.

On the other hand, in the coating apparatus, the temperature-adjusting medium may be cold medium using water or air (for example, cold water or cold air), and the temperature adjustment unit may be a cooling device to cool the processing container. Furthermore, the temperature-adjusting medium may be hot medium using water or air (for example, hot water or hot air), and the temperature adjustment unit may be a heating device to heat the processing container.

According to the present invention, since there is provided a coating apparatus that includes a hollow processing container which is rotatably arranged with its rotation axis being the center, and a ventilation section which is arranged in the processing container, and can ventilate the inside of the processing container and the outside of the processing container in the coating processing, wherein the ventilation section has a temperature adjustment unit which is provided with a temperature-adjusting section through which temperature-adjusting medium passes, and a communicating section which makes the inside of the processing container communicate with the outside of the processing container, in the coating processing, the temperature adjustment unit can adjust the temperature of the processing container, especially the ventilation section, while carrying out ventilation. Accordingly, in the coating processing, the temperature difference can be brought about between the inside of the processing container and processing objects, which can prevent coating base materials from adhering to the inside of the processing container, especially the ventilation section.

### BRIEF DESCRIPTION OF THE DRAWINGS

FIG. 1 shows a view to explain the configuration of a coating apparatus in the first embodiment according to the present invention;

FIG. 2 shows a sectional view indicative of the configuration of a rotary joint;

FIG. 3 shows a view to explain the connection configuration between the rotary joint and a drive shaft;

FIG. 4 shows a view to explain the configuration of ventilation sections, and shows a surface on the inner side of a rotating drum;

FIG. 5 shows a view to explain the configuration of the ventilation sections, and shows a surface on the outer side of the rotating drum;

FIG. 6 shows a plan view of a panel unit;

FIG. 7 shows a side view of the panel unit;

FIG. 8 shows a view to explain the configuration of a panel unit used in a coating apparatus in the second embodiment according to the present invention;

FIG. 9 shows a view to explain the configuration of a panel unit used in a coating apparatus in the third embodiment according to the present invention;

FIG. 10 shows a view to explain the configuration of a coating apparatus in the fourth embodiment according to the present invention;

FIG. 11 shows a view to explain the configuration of a coating apparatus in the fifth embodiment according to the present invention;

FIG. 12 shows a view to explain the configuration of a panel unit used in the coating apparatus in FIG. 11; and

FIG. 13 shows a view to explain the configuration of a conventional coating apparatus.

### DETAILED DESCRIPTION OF THE PREFERRED EMBODIMENT

Now, the present invention will be described in greater detail by referring to the accompanying drawings that illustrate preferred embodiments of the invention.

### First Embodiment

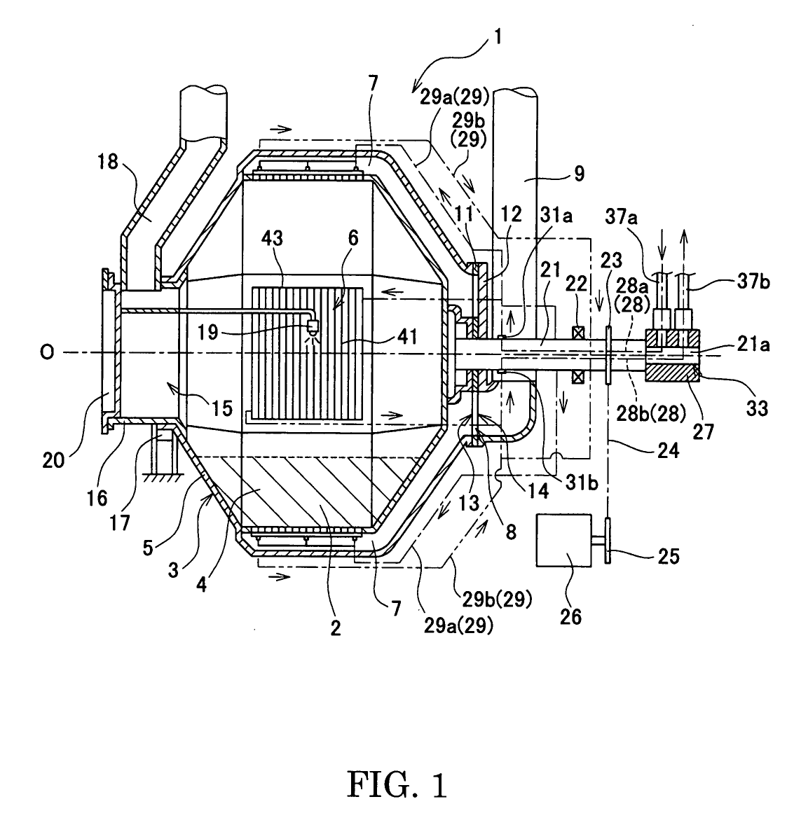

FIG. 1 shows a view to explain the configuration of a coating apparatus 1 in the first embodiment according to the present invention. The coating apparatus 1 shown in FIG. 1 is a powder and particle processing apparatus that is generally called a pan coating apparatus. The coating apparatus 1 performs desired processing such as granulating, coating, drying, mixing processing objects by rotating a rotating drum using processing gas passing therethrough and coating materials. In this embodiment, as the coating apparatus 1, there is employed a device for coating processing objects such as tablets or sweets with glycocalyx liquid etc mainly configured by syrup obtained by dissolving saccharose into water.

The coating apparatus 1 is provided with a rotating drum (coating pan: processing container) 3 in the form of a lateral-type drum that contains tablets (processing objects) 2. The drum 3 includes a hollow main trunk section 4, and end walls 5 which are arranged at both sides of the main trunk section 4 in the axis direction, and is so arranged as to be rotatable with the horizontal axis line “O” being the rotation center. The main trunk section 4 is in the form of a cylinder of polygonal configuration (octagon, for example) or circular configuration in cross-section. The main trunk section 4 is provided with, around several parts of circumference or entire circumference thereof, ventilation sections 6 through which processing gas such as hot air or cold air passes. Around the outer circumference of the main trunk section 4, charge/discharge jacket rooms 7 are individually arranged for the respective ventilation sections 6, covering the ventilation sections 6. The respective charge/discharge jacket rooms 7 are coupled to a charge/discharge tube 9 arranged at the right side of the drum 3 in FIG. 1 through a selection ventilation section 8.

The selection ventilation section 8 includes a first disc plate 11 which is arranged at the end of the drum 3, and a second disc plate 12 to which the charge/discharge tube 9 is attached. In the selection ventilation section 8, only when the drum 3 is located at a predetermined rotation position, a specific one of the jacket rooms 7 is made to communicate with the charge/discharge tube 9. The disc plate 11 is provided with openings 13 of the jacket rooms 7. The disc plate 12 is provided with an opening 14 of the charge/discharge tube 9. The disc plate 11 and disc plate 12 face and slide on each other. When the drum 3 rotates, the respective openings 13 face the opening 14 sequentially, and one of the jacket rooms 7 provided with the opening 13 facing the opening 14 is made to communicate with the charge/discharge tube 9. In the coating apparatus 1, as shown in FIG. 1, one of the jacket rooms 7 that comes to locate at the lowest position of the drum 3 communicates with the charge/discharge tube 9.

The left end of the drum 3 in FIG. 1 is provided with an opening 15. To the opening 15, a cylindrical ventilation tube 16 is attached. The ventilation tube 16 is fixed, and the drum 3 is rotatably supported by a bearing 17 with respect to the ventilation tube 16. The tube trunk of the ventilation tube 16 has attached thereto a charge/discharge tube 18. The ventilation tube 16 communicates with the charge/discharge tube 18. When charging gas from the charge/discharge tube 18, processing gas is supplied into the drum 3 from the charge/discharge tube 18 through the ventilation tube 16. Processing gas in the drum 3 is sent to the outside of the drum 3 to be discharged from the charge/discharge tube 9 through above described jacket rooms 7.

The tube trunk of the ventilation tube 16 has also attached thereto a spray unit 19. The spray unit 19 supplies glycocalyx liquid etc. to tablets in the drum 3. Furthermore, the ventilation tube 16 has attached to the front surface thereof an opening/closing cover 20. When throwing tablets into the drum 3 and taking out products which has undergone coating processing, the cover 20 is opened.

The drum 3 has attached to the right end thereof in FIG. 1 a drive shaft 21. The shaft 21 is rotatably supported by a bearing 22. The shaft 21 has attached thereto a sprocket 23. The sprocket 23 is connected to a sprocket 25 through a chain 24. The sprocket 25 is driven by a motor 26. When the motor 26 operates, the shaft 21 is driven to be rotated, which makes the drum 3 rotate with the horizontal axis line “O” being the rotation center. The shaft 21 has attached to the end thereof a rotary joint 27. The joint 27 is coupled to a charge/discharge system for cold and hot medium, not shown, including a pump and a heat exchanger which are arranged at the outside of the coating apparatus 1.

As shown in FIG. 1, the coating apparatus 1 is so configured as to supply cold water (cold medium) as temperature-adjusting medium to the ventilation sections 6 of the drum 3 through the joint 27, a communication hole 28, and a charge/discharge tube 29. Cold air can be used as the cold medium, while cold water which is excellent in cooling efficiency as compared with cold air is used in this embodiment. The communication hole 28 is composed of a charge hole 28a and a discharge hole 28b. The charge hole 28a and discharge hole 28b are provided in the shaft 21. The shaft 21 is provided with at the left end thereof in FIG. 1 connection ports 31a and 31b for the charge hole 28a and discharge hole 28b. The respective connection ports 31a and 31b have attached thereto the charge/discharge tube 29 (a charge tube 29a and a discharge tube 29b) made of synthetic resin. The shaft 21 is provided with at the right end thereof in FIG. 1 openings 32a and 32b for the charge hole 28a and discharge hole 28b (refer to FIG. 3). The openings 32a and 32b are connected to the joint 27.

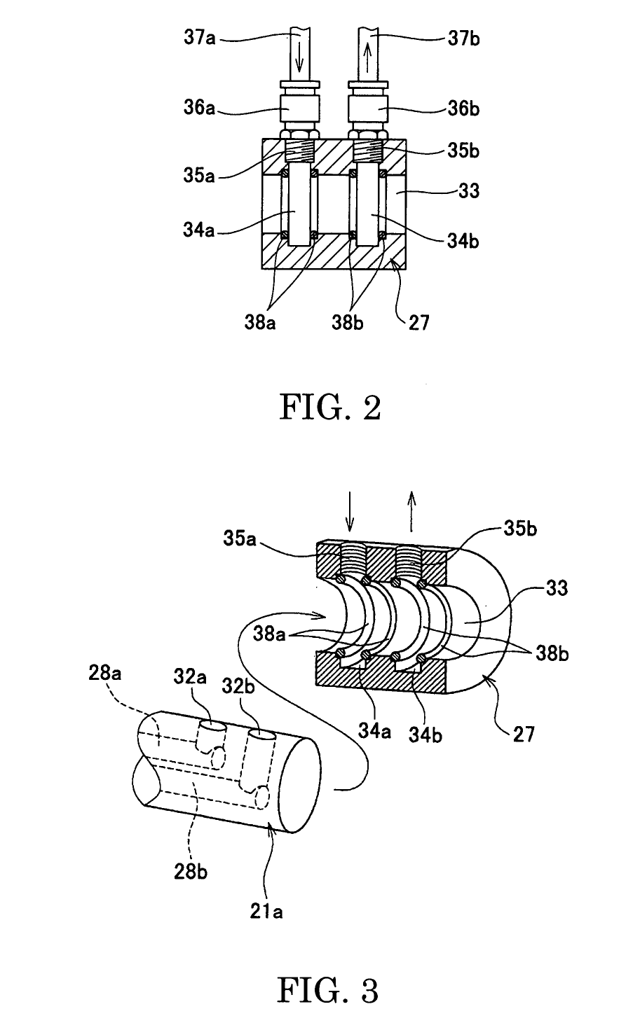

FIG. 2 shows a sectional view indicative of the configuration of the rotary joint 27, while FIG. 3 shows a view to explain the connection configuration between the joint 27 and the shaft 21. As shown in FIG. 2, the joint 27 is provided with at the center thereof a mounting hole 33. To the mounting hole 33, the end of the shaft 21 is rotatably inserted. The peripheral wall of the mounting hole 33 is provided with two circumference grooves 34a and 34b in the form of recesses. The grooves 34a and 34b are formed over the entire wall circumference of the mounting hole 33. The grooves 34a and 34b have attached thereto at the front and back thereof packings 38a and 38b so as to prevent water from leaking from the grooves 34a and 34b. The joint 27 has formed thereon at the upper part thereof in FIG. 2 and FIG. 3 two connection holes 35a and 35b. The holes 35a and 35b communicate with the grooves 34a and 34b in the joint 27 respectively. The connection holes 35a and 35b have formed therein an internal thread respectively. To the holes 35a and 35b, caps 36a and 36b are attached. To the caps 36a and 36b, connection tubes 37a and 37b are connected. The connection tubes 37a and 37b are coupled to above-described cold and hot medium charge/discharge system.

The shaft 21 has its end 21a provided with openings 32a and 32b corresponding to the grooves 34a and 34b of the joint 27. That is, when mounting the shaft 21 to the joint 27, the opening 32a is made to face and communicate with the groove 34a, while the opening 32b is made to face and communicate with the groove 34b. When the shaft 21 rotates, the openings 32a and 32b are made to shift accordingly in the circumferential direction, while the openings 32a and 32b constantly face the grooves 34a and 34b when the shaft 21 is rotating. Accordingly, the charge hole 28a and discharge hole 28b are constantly kept communicating with the connection tubes 37a and 37b. As a result, when the drum 3 is operated, the coating apparatus 1 can always charge and discharge temperature-adjusting medium.

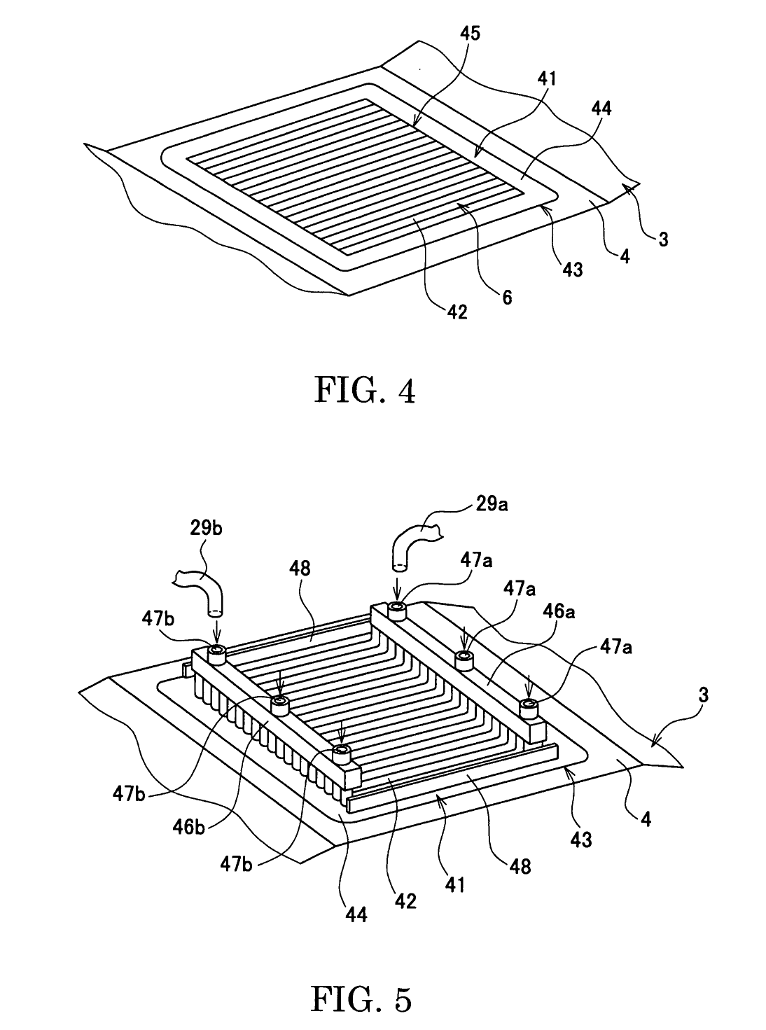

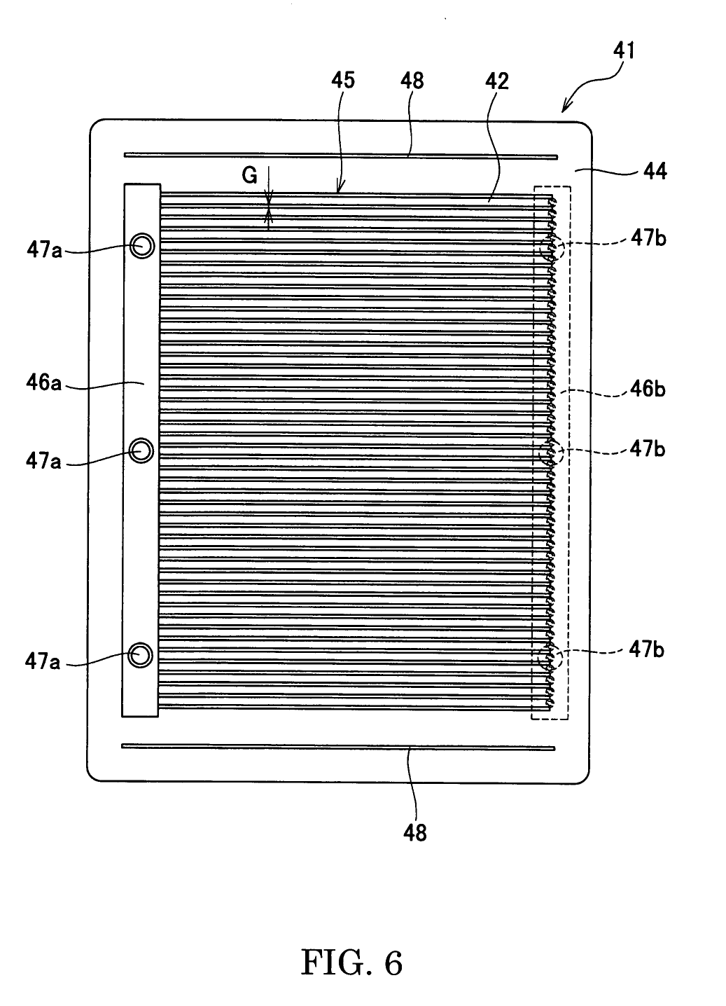

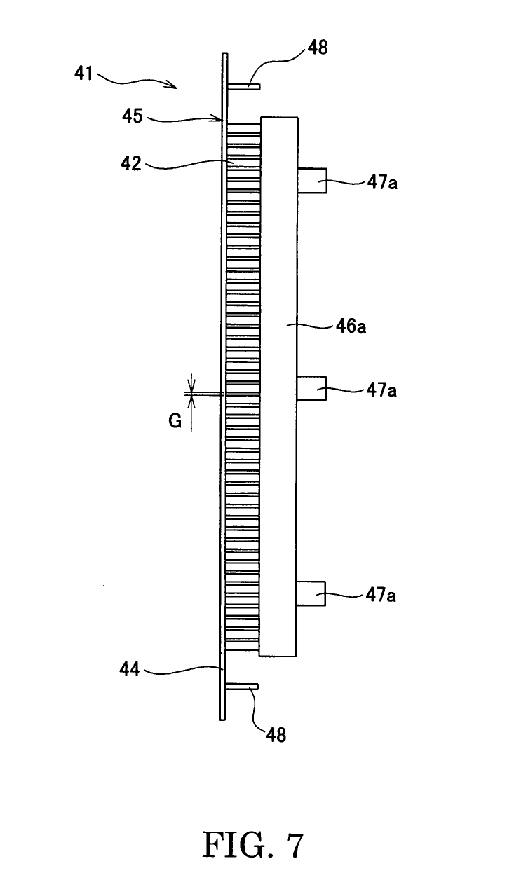

The tube 29, which is attached to the connection ports 31a and 31b of the shaft 21, is coupled to a panel unit (temperature adjustment unit) 41 that is attached to the ventilation sections 6. FIG. 4 and FIG. 5 show views to explain the configuration of the ventilation sections 6. FIG. 4 shows a surface on the inner side of the drum 3, while FIG. 5 shows a surface on the outer side (jacket rooms 7 side) of the drum 3. Furthermore, FIG. 6 shows a plan view of the unit 41, while FIG. 7 shows a side view (left side in FIG. 6) of the unit 41. As shown in FIG. 4 and FIG. 5, to the ventilation sections 6, the unit 41 provided with hollow pipes (temperature-adjusting section; temperature-adjusting tubes) 42 through which temperature-adjusting medium passes is attached. The unit 41 is fixed to a fixing hole 43 formed on the main trunk section 4 of the drum 3 using clips, not shown.

As shown in FIG. 6 and FIG. 7, the unit 41 has a stainless base plate 44 in the form of a flat plate (for example, 483 to 487 mm×349 mm×3 mm) to which the plural (47 in this embodiment) hollow pipes 42 are attached. To both ends of the plate 44 in the longitudinal direction (drum rotation direction), a bracket 48 is perpendicularly attached respectively. Each of the brackets 48 has attached thereto above-described two fixing clips. The main trunk section 4 of the drum 3 has formed thereon engagement sections, not shown, with which the fixing clips are to be engaged. When the fixing clips are engaged with the engagement sections, the unit 41 is fixed to the drum 3. In this case, the unit 41 is attached to the drum 3 from the outside thereof, and the unit 41 is mounted to the fixing hole 43 such that the plate 44 covers the fixing hole 43.

Each of the pipes 42 is a stainless hollow round pipe (for example, φ6, wall thickness 1 mm). The pipes 42 are so formed as to be shorter than the width of the plate 44. The plate 44 is provided with at the center thereof a rectangular communication hole 45. The pipes 42 are so arranged as to face the communication hole 45. Between the adjacent pipes 42, a gap (communicating section) “G” of a predetermined dimension (2 mm in this embodiment) is provided. The respective pipes 42 are fixed to the plate 44 by welding, facing the communication hole 45, such that the adjacent pipes 42 are parallel with each other. The pipes 42 are arranged such that the tops thereof are on a level with the surface of the plate 44 on the inner side of the drum 3.

To both ends of the pipes 42, charge/discharge collecting pipes (temperature-adjusting medium charge/discharge collecting members) 46a and 46b being stainless square pipes (for example, 25 mm on a side) are fixed by welding. In FIG. 6, so as to clarify the configuration of the pipes 42, the pipe 46b of the right side is shown by a dotted line. To the pipe 46a, three charge ports 47a are fixed, while to the pipe 46b, three discharge ports 47b are fixed, by welding respectively. In the coating apparatus 1, the charge tube 29a is connected to the charge ports 47a, while the discharge tube 29b is connected to the discharge ports 47b, respectively. In the coating processing, temperature-adjusting medium (cold water, in this embodiment) is supplied to the pipes 42 constantly or arbitrarily. The tubes 29a and 29b are conducted to the inside of the jacket rooms 7 from the outside of the jacket rooms 7, keeping the airtightness, through a mounting hole, not shown.

In this way, in the coating apparatus 1, the ventilation sections 6 are formed using the unit 41 in which the pipes 42 are arranged with uniform gaps provided thereamong. In the ventilation sections 6, the pipes 42 are so arranged as to be exposed to the inside of the drum 3, and between the adjacent pipes 42, the gap “G” is arranged so as to make the inside of the drum 3 communicate with the jacket rooms 7. The pipes 42 are supplied with cold water, which can directly cool the ventilation sections 6. That is, the ventilation sections 6 are provided with a self-cooling function, and can make processing gas pass therethrough, which can prevent the ventilation sections 6 from being heated by the processing gas in the coating processing. In a coating apparatus in which parts where the ventilation sections 6 are not arranged exist in the main trunk section 4, heat of the parts where the ventilation sections 6 are not arranged is conducted to the ventilation sections 6 to be released. Accordingly, a coating apparatus in which parts where the ventilation sections 6 are not arranged exist can suppress the temperature rise of the drum 3.

Next, the coating processing in the coating apparatus 1 will be explained by employing an example of producing glycocalyx tablets. In this example, firstly, tablets 2 (for example, diameter 8 mm, 200 mg/T) such as lactose tablets are thrown into the drum 3 as processing objects, and then the drum 3 is made to rotate (for example, approximately 8 rpm) by driving the motor 26. When the drum 3 rotates, the tablets 2 are raised in the rotation direction along the main trunk section 4 and end walls 5 to be let down in the inside, and are rolled in the drum 3. To the tablets 2, while the drum 3 is rotating, glycocalyx liquid is sprayed (for example, in case the amount to process glycocalyx tablets is approximately 100L, 60° C., 340 to 900 ml/time) from the spray unit 19. At this time, the charge/discharge tube 18 arbitrarily sends hot air (for example, 70° C., 12 m³/min) so as to solidify and form a glycocalyx film on the tablets 2.

On the other hand, in the coating apparatus 1, in the coating processing, the ventilation sections 6 are cooled by arbitrarily supplying cold water to the pipes 42. To the pipes 42, cold water is charged and discharged through the joint 27, communication hole 28, and tube 29. That is, cold water supplied from the cold and hot medium charge/discharge system is sent to the tube 37a, cap 36a, connection hole 35a, groove 34a, and opening 32a, in this order, and flows into the tube 29a from the charge hole 28a through the connection port 31a. Then, the cold water flows into the inside of the pipe 46a from the charge ports 47a to flow into the pipes 42. On the other hand, the cold water that is heated by the pipes 42 to be discharged flows into the inside of the pipe 46b, and gets to the connection port 31b from the discharge ports 47b through the tube 29b. Then, the discharged cold water is sent to the connection port 31b, discharge hole 28b, and opening 32b, in this order, entering into the inside of the joint 27, and is sent to the groove 34b, connection hole 35b, cap 36b, and tube 37b, in this order, returning to the cold and hot medium charge/discharge system.

In this way, in the coating apparatus 1, since the pipes 42 are arranged with uniform gaps provided thereamong in the ventilation sections 6, the drum 3, specifically the ventilation sections 6 can be directly cooled and, concurrently, the ventilation can also be carried out. Accordingly, in the coating processing, the temperature of the drum 3 can be kept low to bring about the temperature difference between the inside of the drum 3 and the tablets 2, making it possible to prevent glycocalyx liquid from adhering to the inside of the drum 3, especially ventilation sections 6. As a result, a spot or a protrusion raised due to the peeling off of the adhering materials can be prevented from occurring, making it possible to reduce the incidence rate of defective products. Furthermore, since the amount of materials adhering to the inside of the drum 3 is small, the number of times for cleaning, man-hour for cleaning, and the cleaning time period for the drum 3 can be reduced, which can accordingly carry out the coating processing effectively, also making it possible to reduce the process time period.

Furthermore, in the coating apparatus 1, it is possible to arbitrarily adjust the temperature of the ventilation sections 6 by controlling the temperature and amount of cold water to be supplied to the ventilation sections 6. Accordingly, the optimum drum temperature can be maintained according to the processing condition, which can realize the coating processing more effectively. In addition, the unit 41 can be easily mounted to an existing coating apparatus by making alterations to the coating apparatus, which can make it possible to apply the present invention to an existing coating apparatus without making the cost significantly high.

### Second Embodiment

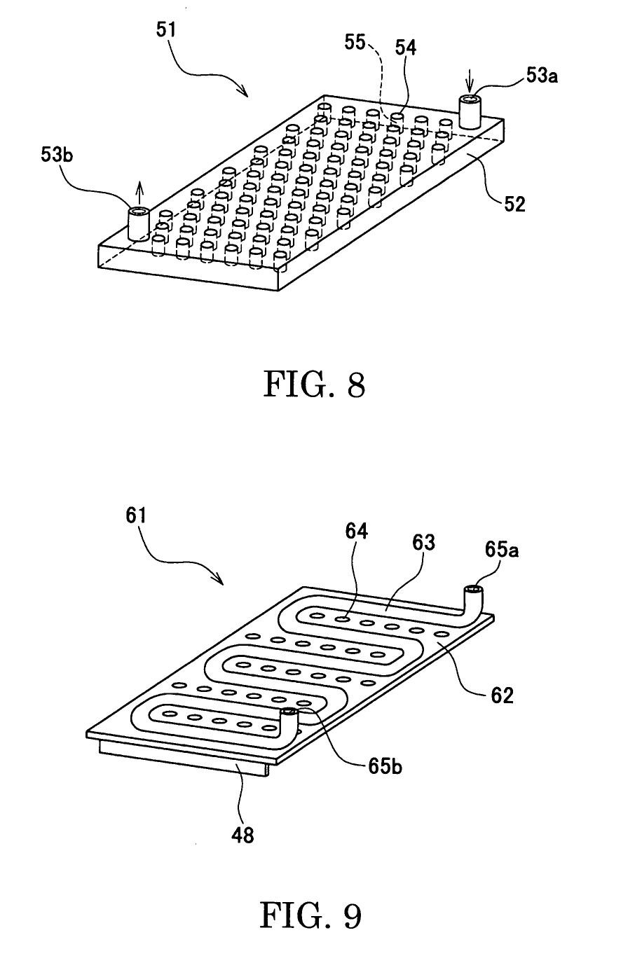

Next, a coating apparatus of the second embodiment according to the present invention will be explained. FIG. 8 shows a view to explain the configuration of a panel unit (temperature adjustment unit) 51 used in a coating apparatus in the second embodiment. Similar to the unit 41 in the first embodiment, the unit 51 is fixed to the fixing hole 43 formed on the main trunk section 4 of the drum 3, configuring the ventilation sections 6. The configuration other than that of the panel unit 51 is similar to that of the coating apparatus 1 in the first embodiment. In the following embodiments, parts or components similar to those in the first embodiment are indicated with the same reference numerals, and detailed explanation of which will be omitted.

In the unit 51, cold water (temperature-adjusting medium) is supplied to a panel box (temperature-adjusting section) 52 in the form of a box. The box 52 is of hollowed configuration. The box 52 is provided with at two corners thereof a charge port 53a and a discharge port 53b which communicate with the internal space thereof. Furthermore, the box 52 is provided with a lot of ventilation holes (communicating section) 54 to make the top surface side thereof with the rear surface side thereof. The ventilation holes 54 are formed by arranging pipes 55 through the box 52. The ventilation holes 54 do not communicate with the internal space of the box 52.

In the coating apparatus having thus configured unit 51, in the coating processing, cold water is arbitrarily supplied to the box 52 to cool the ventilation sections 6, similar to the aforementioned case. To or from the box 52, cold water is charged or discharged through the joint 27, communication hole 28, and tube 29. Thus, the drum 3, specifically the ventilation sections 6 can be directly cooled and, concurrently, the ventilation can also be carried out. Accordingly, in the coating processing, the temperature of the drum 3 can be kept low to bring about the temperature difference between the inside of the drum 3 and the tablets 2, making it possible to prevent glycocalyx liquid from adhering to the inside of the drum 3, especially ventilation sections 6.

### Third Embodiment

FIG. 9 shows a view to explain the configuration of a panel unit (temperature adjustment unit) 61 used in a coating apparatus in the third embodiment according to the present invention. Similar to the unit 41 in the first embodiment, the unit 61 is fixed to the fixing hole 43 formed on the main trunk section 4 of the drum 3, configuring the ventilation sections 6. In this case, the configuration other than that of the panel unit 61 is similar to that of the coating apparatus 1 in the first embodiment. In the unit 61, a base plate 62 has formed thereon (outside surface of the drum 3) a hollow pipe (temperature-adjusting section; temperature-adjusting tube) 63. The plate 62 is a porous plate, and is provided with a lot of ventilation holes (communicating section) 64 to make the top surface side thereof with the rear surface side thereof. The pipe 63 has its one end set to a charge port 65a, and has its other end set to a discharge port 65b, to and from which cold water is charged and discharged through the tube 29, similar to the aforementioned case.

In the coating apparatus having thus configured unit 61, in the coating processing, cold water is arbitrarily supplied to the pipe 63 to cool the ventilation sections 6, similar to the aforementioned case. To or from the pipe 63, cold water is charged or discharged through the joint 27, communication hole 28, and tube 29. Thus, in the coating apparatus, the drum 3, specifically the ventilation sections 6 can be directly cooled and, concurrently, the ventilation can also be carried out. Accordingly, in the coating processing, the temperature of the drum 3 can be kept low to bring about the temperature difference between the inside of the drum 3 and the tablets 2, making it possible to prevent glycocalyx liquid from adhering to the inside of the drum 3, especially ventilation sections 6.

### Fourth Embodiment

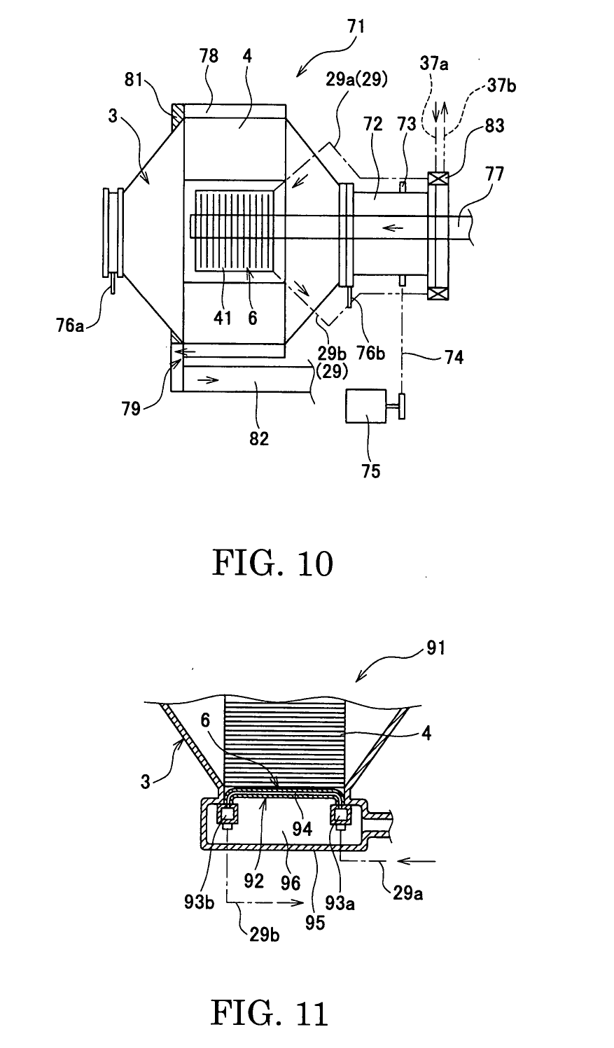

FIG. 10 shows a view to explain the configuration of a coating apparatus 71 in the fourth embodiment according to the present invention. Being different from the coating apparatus 1 shown in FIG. 1, the coating apparatus 71 shown in FIG. 10 is provided with at the right end of the drum 3 a cylindrical shaft 72. The cylindrical shaft 72 has attached thereto a sprocket 73, and is driven by a motor 75 through a chain 74. The drum 3 is rotatably supported by bearings 76a and 76b. To the cylindrical shaft 72, from the outside of the coating apparatus 71, a charge/discharge duct 77 is conducted to be extended into the drum 3. Around the outer circumference of the main trunk section 4 of the drum 3, there are arranged charge/discharge jacket rooms 78. The respective charge/discharge jacket rooms 78 are coupled to a slide disc 81 arranged at the left side of the drum 3 in FIG. 10 through a selection ventilation section 79. The disc 81 is slidably arranged in the right and left direction in FIG. 10, and is made to slide on the charge/discharge jacket rooms 78 at the selection ventilation section 79. The disc 81 is further connected to a charge/discharge tube 82.

The cylindrical shaft 72 is provided at the right end thereof in FIG. 10 a rotary joint 83. The joint 83 is connected to the unit 41 through the tube 29. In the coating processing, similar to the first embodiment, cold water is supplied to the unit 41 from the cold and hot medium charge/discharge system through the joint 83 and tube 29a. The cold water that is heated by the unit 41 is discharged to the cold and hot medium charge/discharge system through the tube 29b and joint 83. Accordingly, the present invention is applicable to a coating apparatus of different configuration, and in the coating apparatus 71 shown in FIG. 10, the drum 3 can be cooled and, concurrently, the ventilation can also be carried out, making it possible to keep the temperature of the drum 3 low in the coating processing.

### Fifth Embodiment

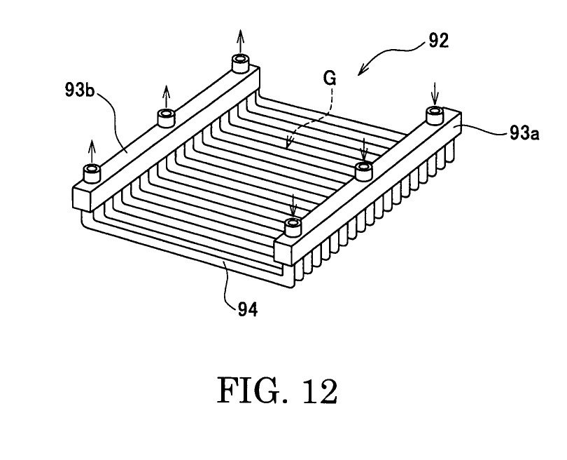

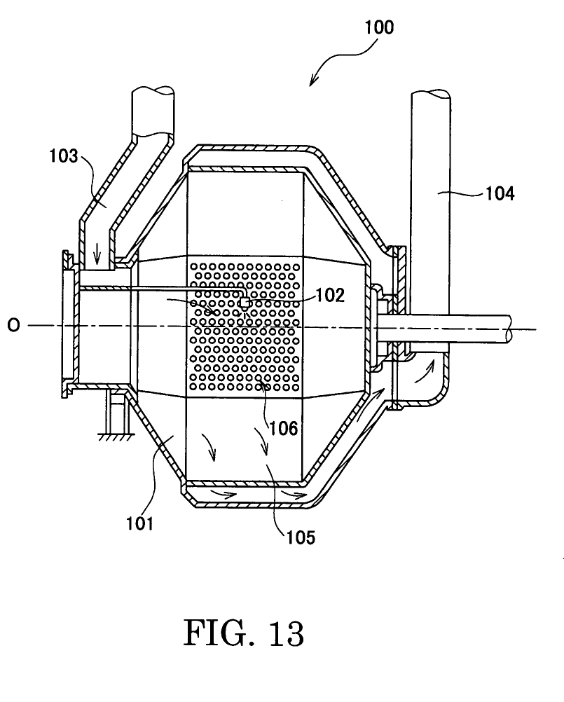

FIG. 11 shows a view to explain the configuration of a coating apparatus 91 in the fifth embodiment according to the present invention. In the coating apparatus 91 shown in FIG. 11, the ventilation sections 6 have attached thereto a panel unit (temperature adjustment unit) 92 that is not provided with the base plate 44. FIG. 12 shows a view to explain the configuration of the panel unit 92. As shown in FIG. 12, the unit 92 is composed of charge/discharge collecting pipes (temperature-adjusting medium charge/discharge collecting members) 93a and 93b, and hollow pipes (temperature-adjusting section; temperature-adjusting tubes) 94. The pipes 94 are prepared by a plural number, and are so arranged as to be parallel with each other. To both ends of the pipes 94, the pipes 93a and 93b are fixed by welding. Between the adjacent pipes 94, a gap “G” of a predetermined dimension is provided.

In the coating apparatus 91 shown in FIG. 11, around the outer circumference of the main trunk section 4, there is arranged a jacket 95 in which charge/discharge jacket rooms 96 are formed. The jacket rooms 96 have the right ends thereof in FIG. 11 connected to the selection ventilation section 8, not shown. The unit 92 is arranged at the boundary of the jacket rooms 96 and the drum 3, forming the ventilation sections 6. The unit 92 is detachable with respect to the main trunk section 4 of the drum 3, and is arbitrarily arranged around several parts of circumference or entire circumference of the main trunk section 4 according to the kind of processing objects or the processing condition. On the other hand, the pipes 93a and 93b may be fixed to the drum 3 by welding etc. so as to unitedly configure the unit 92 and drum 3.

The present invention is by no means limited to the above-described embodiments, which may be modified and altered in various different ways without departing from the spirit and scope of the invention.

For example, in above-described embodiments, configurations in which the unit 41 is used as a cooling device have been explained by taking the glycocalyx coating processing as an example. On the other hand, the coating processing is not restricted to the glycocalyx coating processing, and various types of coating processing can be employed. For example, the present invention can be applied to the chocolate coating processing, in which case heated liquid such as hot water or hot air (hot medium) is supplied to the pipes 42 as temperature-adjusting medium. That is, in this case, the unit 41 is used as a heating device, and directly heats the inside of the drum, especially the ventilation sections 6. Accordingly, in the coating processing, there is brought about the temperature difference between the inside of the drum and processing objects, which can prevent chocolate from adhering to the inside of the drum (especially, ventilation sections 6). As a result, producing defective products due to the peeling off of adhering materials can be prevented, and the number of times for cleaning, man-hour for cleaning, and the cleaning time period for the drum 3 can be reduced, which can accordingly carry out the coating processing effectively, also making it possible to reduce the process time period. Furthermore, the present invention can be applied to the fat processing such as the fat coating (wax) processing, and can also be applied to the sustained release in the fat coating processing.

Furthermore, various dimensions, number of pipes 42, arrangement direction (not only the drum rotation direction but also the horizontal axis direction can be employed), materials of respective members, processing conditions or temperature, time period, amount, etc. in above-described embodiments have been explained as illustrative examples, to which the present invention is not restricted. Processing objects are not restricted to tablets such as above-described lactose tablets, and may be foods such as sweets and gum, or other medicinal drugs. As for the glycocalyx liquid, other than syrup obtained by dissolving saccharose into water, glycocalyx liquid of various specifications can be employed such as glycocalyx liquid having added thereto various medicinal properties and flavors, pigments, etc.

In the first embodiment, a configuration in which the charge/discharge collecting pipes 46a and 46b are used in the unit 41 is explained. On the other hand, the charge/discharge collecting pipes do not have to be necessarily used, and the charge/discharge tube 29 may be directly connected to the respective pipes 42. Furthermore, there may be employed a configuration in which, of the pipes 46a and 46b, only one of them is used and the other is used to directly connect the tube 29 to the respective pipes 42. In this regard, when the charge/discharge collecting pipes are used, the respective pipes can be aggregated, and configuration thereof is suitable for practical use. The number of the charge ports 47a and discharge ports 47b of the pipes 46a and 46b are not restricted to three, and may be one or plural number other than three.

In addition, in the first and third embodiments, a round pipe of circular configuration in cross-section is employed as each of the pipes 42 and the pipe 63. On the other hand, a polygonal pipe of triangle configuration or quadrangular configuration in cross-section may be employed. Furthermore, in above-described embodiments, the pipes 42 are arranged in the ventilation sections 6. On the other hand, in case of a coating apparatus in which parts where the ventilation sections 6 are not arranged exist in the main trunk section 4, the pipes 42 may be arbitrarily arranged in the main trunk section so as to improve the temperature adjustment function of the drum 3.

On the other hand, in above-described embodiments, coating apparatuses of horizontally rotating drum type in which the drum 3 rotates with the horizontal axis line being the rotation center have been explained. On the other hand, the present invention is not restricted to above-described configurations, and a coating apparatus having an inclined rotating drum that has its rotation axis line inclined with respect to the ground plane may be employed. Furthermore, in above-described embodiments, the present invention is applied to jacket type coating apparatuses in which the drum 3 has arranged on the outer circumference thereof the jacket rooms 7 or 78. On the other hand, the present invention may be applied to a jacketless type coating apparatus in which the drum 3 does not have arranged on the outer circumference thereof the jacket rooms 7 or 78.

What is claimed is:

1. A coating apparatus, comprising:
a hollow processing container which is rotatably arranged with its rotation axis being the center; and
a ventilation section which is arranged in the processing container, and can ventilate the inside of the processing container and the outside of the processing container in the coating processing;
wherein the ventilation section has
a temperature adjustment unit which is provided with a temperature-adjusting section through which temperature-adjusting medium passes, and a communicating section which makes the inside of the processing container communicate with the outside of the processing container.

2. The coating apparatus according to claim 1, wherein the temperature-adjusting section has hollow temperature-adjusting tubes through which the temperature-adjusting medium passes.

3. The coating apparatus according to claim 2, wherein the temperature-adjusting tubes are prepared by a plural number, and a gap is provided between the adjacent temperature-adjusting tubes so as to form the communicating section.

4. The coating apparatus according to claim 3, wherein the temperature-adjusting tubes are so arranged as to be parallel with each other.

5. The coating apparatus according to claim 2, wherein the temperature adjustment unit has a base plate in the form of a flat plate which is provided with at the center thereof a communication hole, and the temperature-adjusting tubes are fixed to the base plate and are so arranged as to face the communication hole.

6. The coating apparatus according to claim 5, wherein the temperature adjustment unit further has temperature-adjusting medium charge/discharge collecting members which are arranged on at least any one of both sides of the temperature-adjusting tubes, and are connected to the ends of the respective temperature-adjusting tubes and communicate with the respective temperature-adjusting tubes.

7. The coating apparatus according to claim 1, wherein the temperature adjustment unit has a temperature-adjusting section being a hollow box-shaped member through which the temperature-adjusting medium passes, and a communicating section being hollow pipes which are arranged in the box-shaped member and open into the front-back both sides of the box-shaped member.

8. The coating apparatus according to claim 2, wherein the temperature adjustment unit has a base plate in the form of a flat plate which is provided with a plurality of ventilation holes, and the temperature-adjusting tube is fixed to the base plate.

9. The coating apparatus according to claim 8, wherein the temperature-adjusting tube is arranged at part of the base plate where the ventilation holes are not provided.

10. The coating apparatus according to claim 2, wherein the temperature adjustment unit has temperature-adjusting medium charge/discharge collecting members which are arranged on both sides of the temperature-adjusting tubes, and are connected to the ends of the respective temperature-adjusting tubes and communicate with the respective temperature-adjusting tubes.

11. The coating apparatus according to claim 1, wherein the temperature-adjusting medium is cold medium using water or air, and the temperature adjustment unit is a cooling device to cool the processing container.

12. The coating apparatus according to claim 1, wherein the temperature-adjusting medium is hot medium using water or air, and the temperature adjustment unit is a heating device to heat the processing container.
